(19) United States
(12) Patent Application Publication
(10) Pub. No.: US 2006/0201760 A1
(43) Pub. Date: Sep. 14, 2006

(54) Hub and braking rotor unit

(76) Inventors: Marco Brunetti, Torino (IT); Franco Galetto, Pinerolo (IT); John Van De Sanden, Nieuwegein (NL)

Correspondence Address: MERCHANT & GOULD PC, P.O. BOX 2903, MINNEAPOLIS, MN, 55402-0903, US

(21) Appl. No.: 10/553,270

(22) PCT Filed: Apr. 15, 2004
(86) PCT No.: PCT/EP04/03965

§ 371 Date: Oct. 12, 2005

(30) Foreign Application Priority Data
Apr. 17, 2003 (IT) TO2003A000305

(51) Int. Cl. F16D 65/12

(52) U.S. Cl. 188/218 XL; 188/218 R

(57) ABSTRACT

The unit has a rotating hub (10) having an outwardly projecting radial flange (11) defining an outwardly facing edge (12), and a braking rotor (20) which is integral with or fixed for rotation with a flange (21, 41) which projects radially inwards and which defines an opening (23, 43) with an internal edge (22, 42). The edges (12 and 22, 42) of the two flanges (11 and 21, 41) are adjacent to each other and face each other radially. The two edges (12 and 22, 42) have, at least along one portion thereof, the same noncircular shape, for example an oval or lobe shape, in the same radial plane in order to enable the braking torque to be transmitted from the braking rotor (20) to the hub (10). The braking rotor may be mounted on the hub flange (11) by way of an annular support member (40).

The present invention relates to a hub and braking rotor unit of the type specified in the preamble of claim 1.

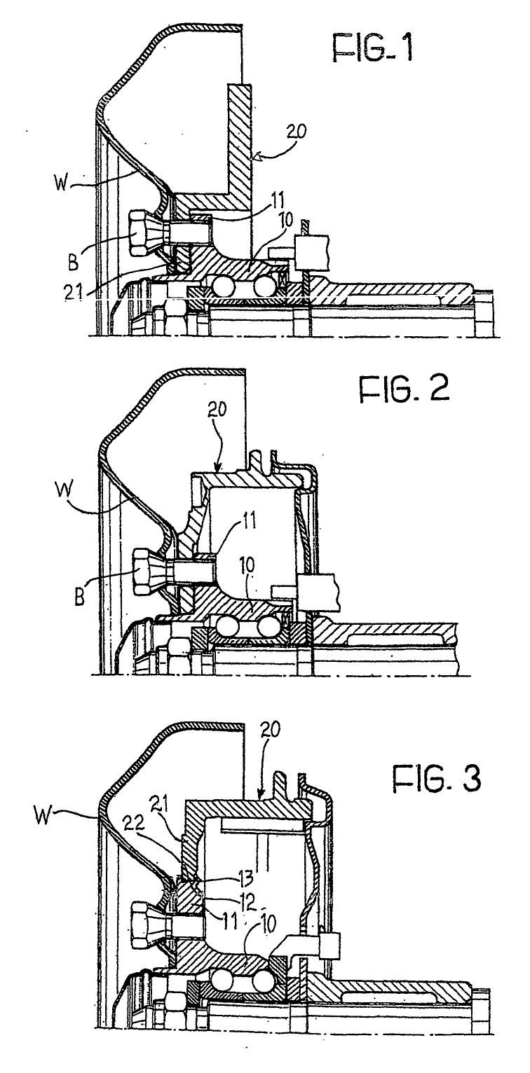

For a better understanding of the prior art and of the problems inherent therein, a description will first be given of some hub and braking rotor units of the traditional type, referring to FIGS. 1 to 3 in the appended drawings.

It is known that the hub of a vehicle wheel has to be securely connected to the brake rotor (disc or drum) in order to transmit the braking torque from the brake to the wheel. FIGS. 1 and 2 illustrate in partial axial section two traditional solutions with a disc brake and a drum brake, respectively. In those traditional configurations, the wheel W, an internal radial flange 21 of the brake rotor 20 and an external radial flange 11 of the hub 10 are placed over one another axially in such a manner as to interpose the flange 21 of the brake rotor between the wheel and the hub flange 11. Those three components are joined by screwing in the wheel-mounting bolts B with the prescribed tightening torque. The tightening of the bolts brings about an axial compression of the central portion of the wheel which, owing to errors of flatness, may produce deformation of the braking surface.

A more recent configuration, described in U.S. Pat. No. 5,988,324 and illustrated here in FIG. 3, provides a rotating hub 10 with an outwardly projecting radial flange 11 defining an external edge 12. The brake rotor 20 has a flange 21 which projects radially inwards and which defines an internal edge 22. The flange 21 of the brake rotor and the flange 11 of the hub are arranged substantially in the same radial plane and are secured to each other by the joint defined by the edges 12 and 22 of the flanges 11 and 21. In order to constrain the brake rotor on the hub, a peripheral portion 13 which projects from the hub flange 11 is cold-deformed. The hub flange is accommodated with radial interference in the opening defined by the internal edge of the brake rotor flange. The disadvantage of that type of coupling is that, in the case of prolonged and repeated braking operations which cause the brake rotor to reach high temperatures, radial thermal expansion of the brake is prevented by the fixed connection to the hub flange. That represents a disadvantage above all for disc-type braking rotors because prevention of the radial thermal expansion of the disc brings about an increase in the flatness errors of the braking surfaces (so-called axial runout). A high degree of axial runout is undesired because it causes excessive vibration, brake juddering and irregular or premature wear of the brake linings.

The object of the present invention is to provide a hub and braking rotor unit of the type discussed in the previous paragraph, which principally tackles the problem of improving the transmission of the braking torque between the brake rotor and the hub.

This and other objects and advantages, which will be better understood hereinafter, are achieved according to the invention by a hub and braking rotor unit having the features defined in the appended claims.

The features and advantages of the invention will emerge from the detailed description of some of its embodiments, which is given with reference to the appended drawings which are provided by way of non-limiting example and in which:

FIGS. 1 to 3 are views in axial section of three traditional hub and braking rotor units;

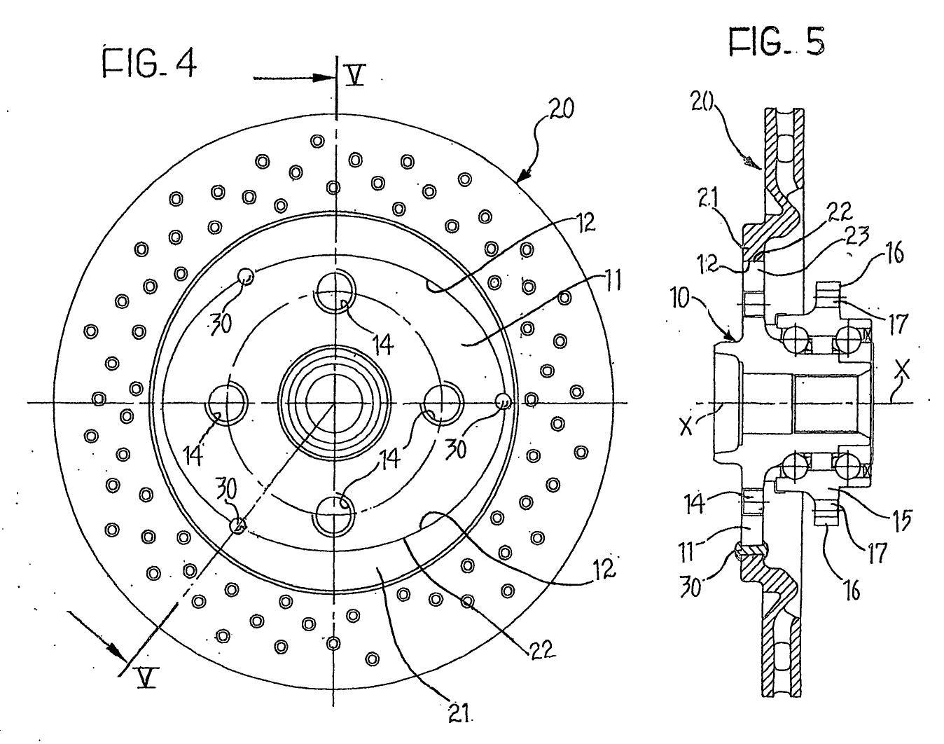

FIG. 4 is a side elevation of a first embodiment of a hub and braking rotor unit according to the invention;

FIG. 5 is a view in axial section taken on the line V-V of FIG. 4;

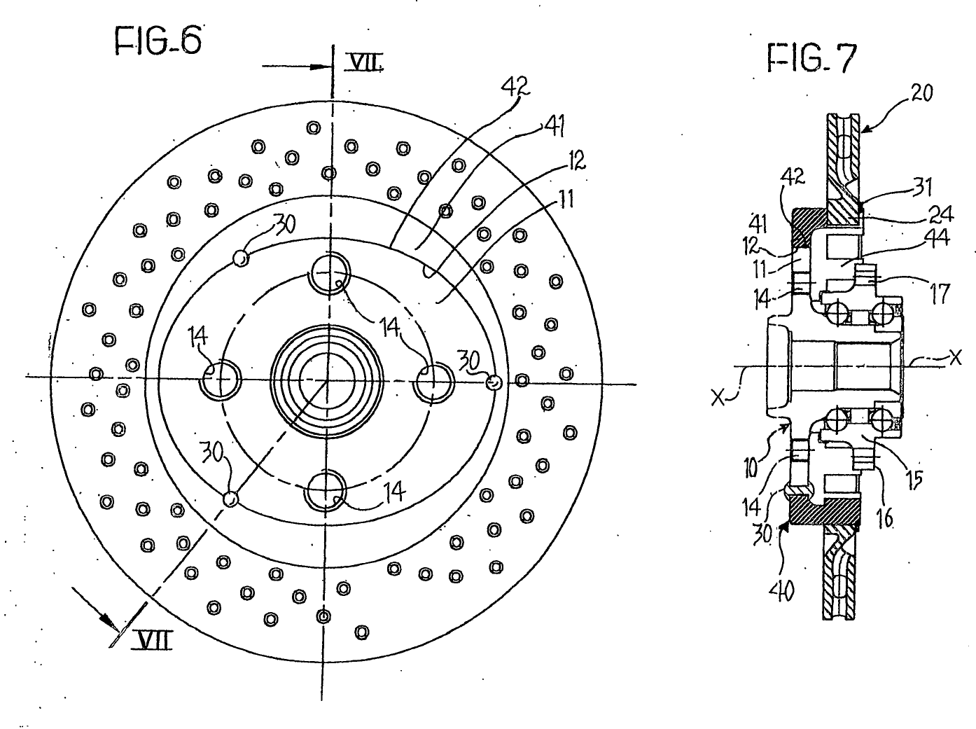

FIG. 6 is a side elevation of a second embodiment of a hub and braking rotor unit according to the invention;

FIG. 7 is a view in axial section taken on the line VII-VII of FIG. 6;

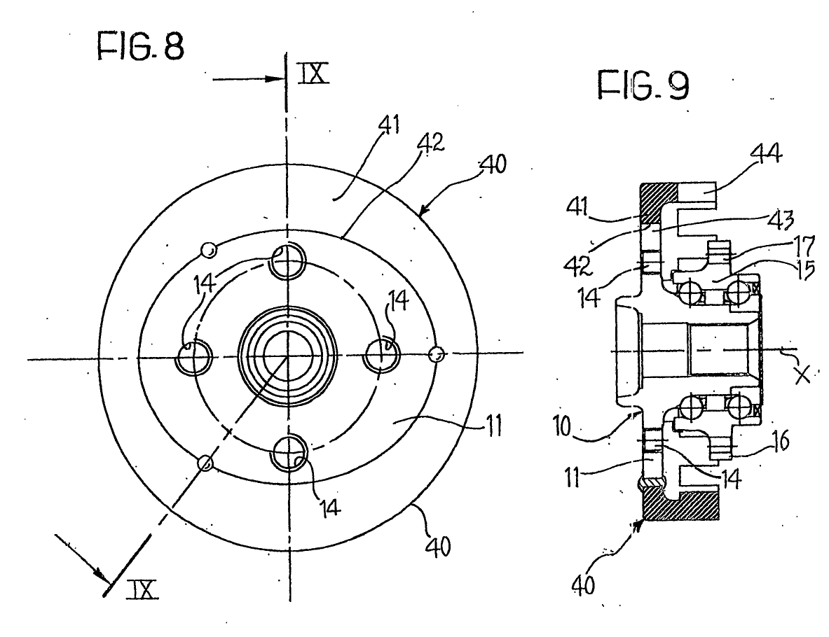

FIG. 8 is a side elevation of two components of the unit of FIG. 6;

FIG. 9 is a view in axial section taken on the line IX-IX of FIG. 8;

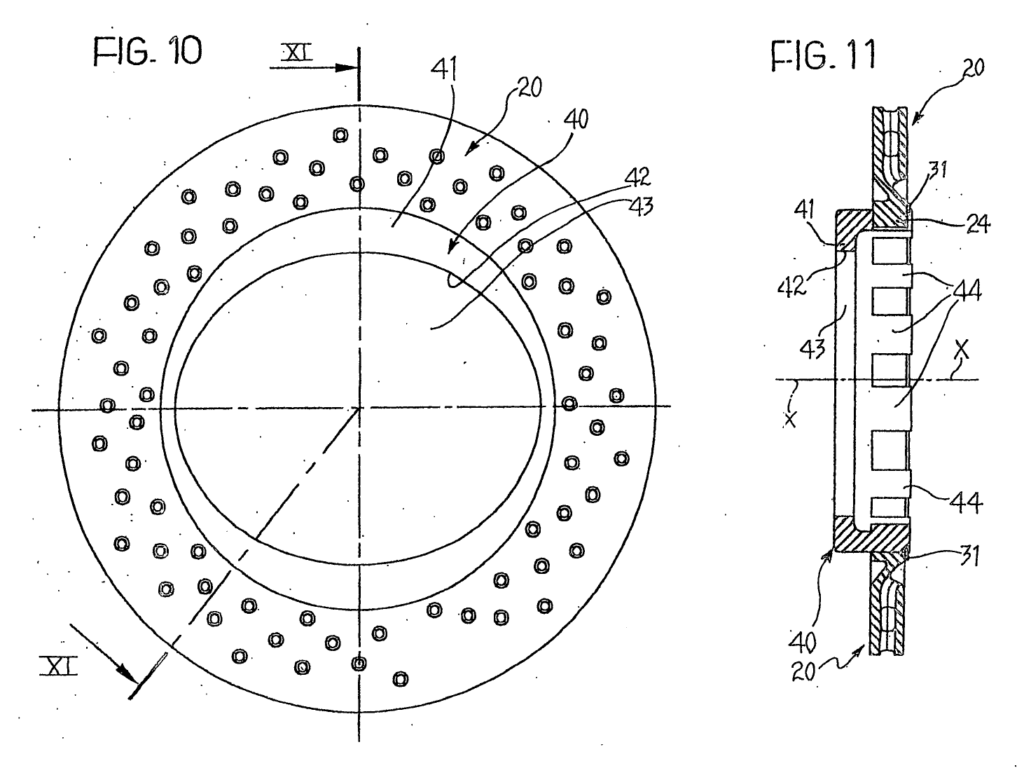

FIG. 10 is a side elevation of two components of the unit of FIG. 6;

FIG. 11 is a view in axial section taken on the line XI-XI of FIG. 10;

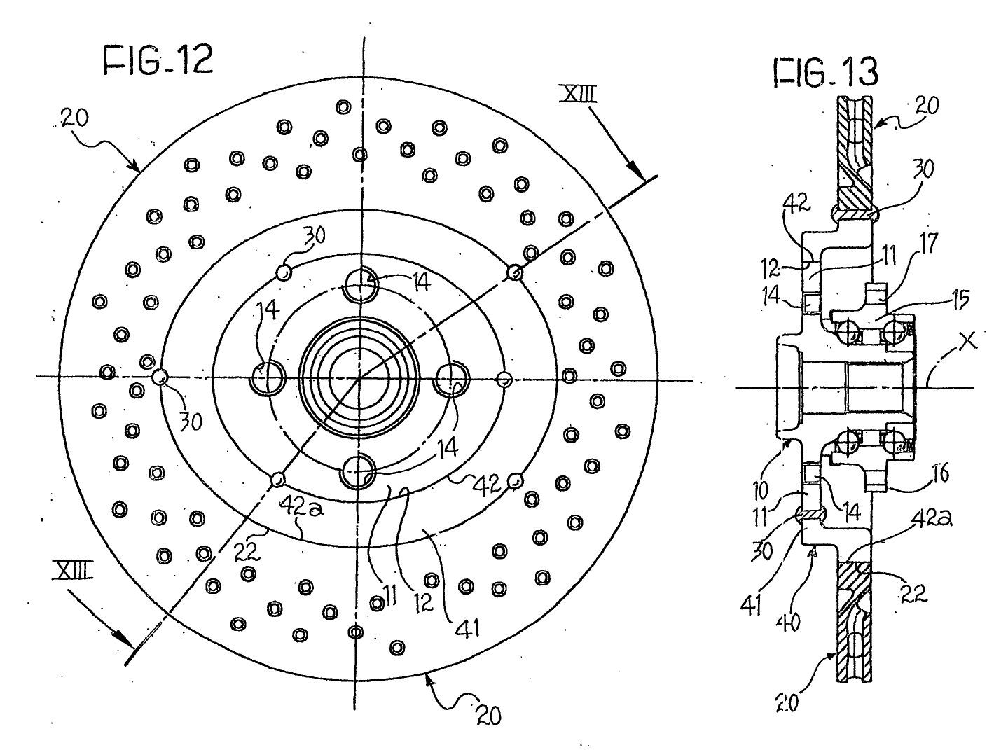

FIG. 12 is a side elevation of a third embodiment of a hub and braking rotor unit according to the invention;

FIG. 13 is a view in axial section taken on the line XIII-XIII of FIG. 12;

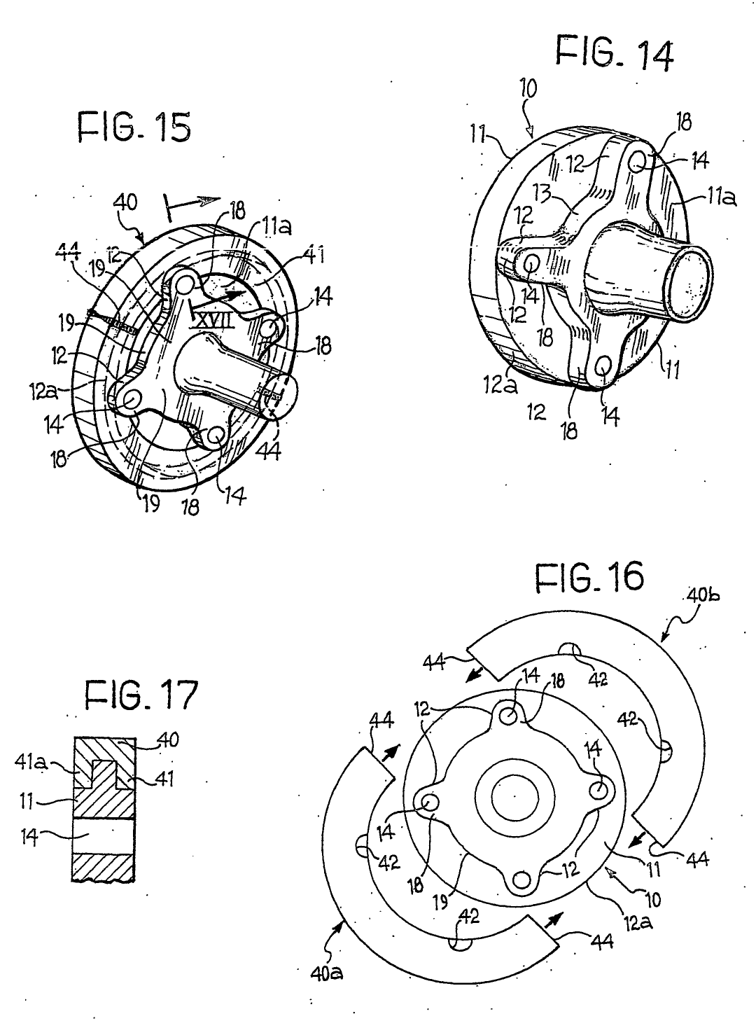

FIG. 14 is a perspective view of a flanged hub of known type;

FIG. 15 is a perspective view illustrating a fourth embodiment of the invention, applied to a hub of the type shown in FIG. 14;

FIG. 16 is an exploded side view of the unit of FIG. 15;

FIG. 17 is a diagrammatic partial view in axial section taken on the line XVII-XVII of FIG. 15;

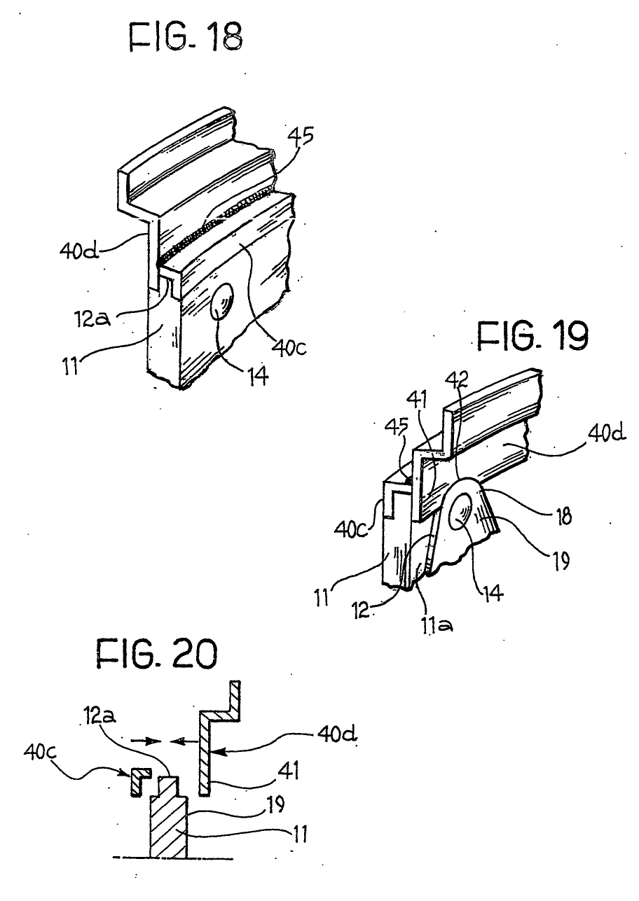

FIGS. 18 and 19 are two partial and diagrammatic perspective views of two opposite sides of a flange of the hub with a brake-carrier member according to a fifth embodiment of the unit according to the invention;

FIG. 20 is an exploded view in axial section of the elements of FIG. 19; and

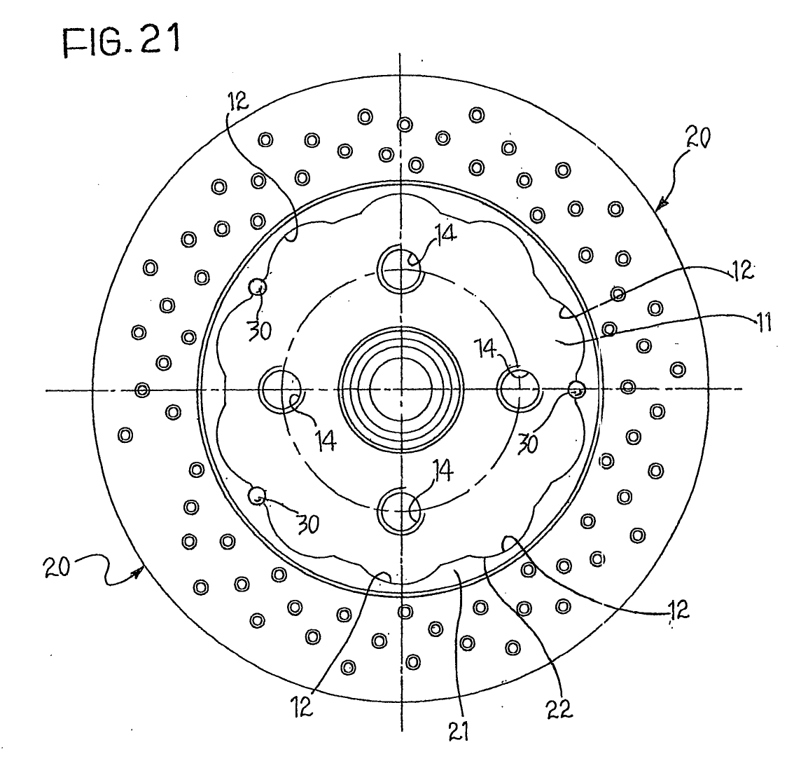

FIG. 21 is a side elevation of a further embodiment of a hub and braking rotor unit according to the invention.

Referring first of all to FIGS. 4 and 5, a first embodiment of the unit according to the present invention comprises a hub 10 and a brake rotor 20. In the description which follows, the examples refer to a braking rotor of the disc type. Of course, the reference to that possible field of application is not in any way to be interpreted as limiting the scope of the patent. On the contrary, the invention is equally applicable to braking rotors of the drum type.

The hub 10 has a flange 11 which extends radially outwards and which forms an external peripheral edge 12. Coupled directly to the hub 10 is the brake rotor 20 which has a flange 21 which projects radially inwards in such a manner as to define an opening 23 with an edge 22. The hub flange 11 is accommodated in the opening 23, and the flanges 11 and 21 lie substantially in the same radial plane. The edges 12 and 22, viewed in the axial direction (FIG. 4), have substantially congruent profiles. Throughout the present description and in the claims which follow, the terms and expressions indicating positions and orientations, such as “axial” and “radial”, are to be understood as referring to the geometric axis of rotation x of the hub in the mounted condition.

An important feature of the solution according to the invention is the fact that the profiles of the edges 12, 22 of the flanges 11, 21 have a non-circular shape in order to enable the braking torque to be transmitted from the brake rotor to the wheel. In the preferred embodiment of the invention, as illustrated in FIG. 4, the shape of the edges 12, 22 of the flanges 11, 21 is generally oval or elliptical. In the variant of FIG. 21, the shape of the above-mentioned edges is multi-lobal.

Preferably, the flange 11 of the hub is accommodated with slight radial clearance (of the order of 0.5-1.5 mm) inside the opening 23 defined inside the edge 22 of the brake rotor flange, in order to permit free expansion in the radial direction of the brake rotor brought about by thermal variations caused by the braking action. That prevents the occurrence of stresses and deformation capable of causing errors of flatness in the braking surfaces, as discussed in the introductory part of the description.

Relative axial movement between the hub 10 and the brake rotor 20 is prevented or limited by a plurality of rivets 30 or other equivalent retaining means which are advantageously fitted at equal angular intervals at the interface between the facing edges 12, 22 of the flanges 11, 21 of the hub and the brake rotor. Alternatively, the means for preventing axial movement between the hub and the brake rotor may provide lateral shoulders, one or a pair of edges which are rolled or cold-deformed in another manner, as described, for example, in U.S. Pat. No. 5,988,324, or one or more retaining members of the Seeger ring type, or, in a less preferred variant, the hub and the brake rotor may be welded along portions of their adjacent edges.

Further embodiments of the invention described hereinafter provide that the brake rotor, which is of the disc type, is not carried directly by the hub but through the interposition of an annular support member called a brake-carrier, marked 40. FIGS. 6 and 7 illustrate the complete unit made up of the hub 10, the brake-carrier 40 and the brake rotor 20. For purely explanatory purposes, FIGS. 8 and 9 illustrate the brake-carrier 40 coupled to the hub 10, and FIGS. 10 and 11 illustrate the brake-carrier coupled to the disc-type braking rotor 20.

The brake-carrier 40 has a flange 41 which projects radially inwards and which defines an opening 43 with an edge 42. The flange 11 of the hub is accommodated in the opening 43, and the flanges 11 and 41 lie substantially in the same radial plane. The edges 12 and 42, viewed in the axial direction (FIGS. 6 and 8), have profiles that are substantially congruent and that are non-circular in shape, preferably oval or elliptical.

As can be seen more clearly in FIG. 9, in an axially offset position relative to the flange 41 (offset towards the axially internal side or inboard side with reference to the condition mounted on a vehicle), the brake-carrier has a toothed or splined portion 44 to which is coupled the brake rotor 20 which has a corresponding toothed or splined portion 24. The transmission of the braking torque from the brake rotor to the wheel is thus ensured by means of the form-fits of the surfaces 24, 44 and 42, 12.

Rivets 30 are provided as retaining means for preventing or at any rate containing the relative axial movement between the hub 10 and the brake-carrier ring 40, while the braking rotor 20 is locked axially on the brake-carrier ring 40 by means of a Seeger retaining ring 31 accommodated in a groove formed in the brake-carrier.

The example of FIGS. 12 and 13 illustrates another variant according to which the brake-carrier ring 40 is coupled for rotation with the hub 10 and with the brake disc 20 by means of two pairs of edges 12, 42 and 42a, 22 which have a non-circular, and preferably oval or elliptical, shape and which are formed, respectively, at the interface between the flange 11 of the hub 10 and the flange 41 of the brake-carrier 40 and between an external flange 41a of the brake-carrier 40 and the brake disc 20. Two series of rivets 30 block or limit, depending on requirements, the relative axial movements of the three components constituting the unit.

In the drawings illustrating the examples discussed above, the flanged hub 10, provided with holes 14 for the bolts (not shown) for securing to the wheel, forms part of a bearing/hub unit having a stationary ring 15 provided with a flange 16 which has holes 17 for bolts for securing to the suspension (not shown) of a motor vehicle. However, it will be appreciated that the invention is not to be understood as being limited to any particular type of bearing/hub unit; the invention is equally applicable to bearing/hub units having a different geometry, for example units in which the rotating ring is the radially external ring and the hub for the wheel is formed by or is integral with that rotating ring.

FIG. 14 illustrates a bearing/hub unit of known type where the holes 14 for the bolts for securing to the wheel (in this example four holes 14 are provided) are in the vicinity of the vertex of four respective radially extending arm or lobe formations 18 formed by a portion 19 which is thickened or at any rate in relief and which projects axially towards the inboard (or axially internal) side from the inboard face 11a of the flange 11 of the hub 10. The flange 11 has an edge 12a having a circular profile, while the axially thickened portion 19 has a multi-lobal peripheral edge marked 12. In the following discussion, reference is made to that non-circular edge 12 of the hub flange.

Referring to FIG. 15, according to a further embodiment of the invention, in order to mount a braking rotor on a hub of the type shown in FIG. 14, use is made of a support or brake-carrier member 40 having a flange 41 which projects radially towards the inside and which defines an edge 42. The edge 42 has a profile which is congruent, or at least partially congruent, with the non-circular peripheral edge 12 of the thickened portion 19 of the hub flange in order to ensure that the braking torque is transmitted from the brake-carrier 40 to the hub 10. As illustrated more clearly in FIG. 16, the edge 42 of the brake-carrier 40 does not copy the shape of all of the edge 12 of the thickened portion 19, but only the shape of the peripheral ends of the (four) arm or lobe formations 18; in other words, the active portion of the edge 42, that is to say, the portion that contributes to the transmission of the braking torque, is constituted by four recesses which accommodate the ends of the radial arm form ations 18.

As illustrated diagrammatically in FIG. 17, the brake-carrier 40 has a substantially C- or U-shaped axial cross-section, with two parallel flanges 41 and 41a which together surround the opposite surfaces (inboard and outboard) of the hub flange 11.

Referring again to FIG. 16, the brake-carrier 40 is preferably formed by joining two complementary curved portions 40a and 40b which, after being arranged on the hub flange, are joined securely to each other at 44 (see also FIG. 15) along a diametral axial plane in order to form a closed ring around the edge 12 of the hub flange 11. The joining by welding of the two portions 40a, 40b forming the brake-carrier 40 is advantageous because it enables those members to be manufactured from weldable steel or other metals or suitable metal alloys, for example of aluminium or titanium. The joining of the portions forming the brake-carrier 40 may be effected by welding, for example laser welding, or explosive welding, brazing or adhesive bonding.

In any case, the manufacture of a brake-carrier according to the invention avoids the problems associated with the traditional direct fusion welding of the brake-carrier to the hub. Direct welding involves difficulties owing to the high carbon content of the steel of the hub. Moreover, the high welding temperatures generate distortions in the hub flange which may necessitate further machining in order to return to acceptable values the axial runout of the surfaces of the two opposite faces of the hub flange.

A further embodiment of a brake-carrier according to the invention is illustrated in FIGS. 18-20 where the brake-carrier 40 is formed by joining two rings of bent sheet-metal 40c and 40d which, after being arranged straddling the circular edge 12a and on both faces of the flange 11, are joined securely to each other along a circumference 45. The sheet-metal ring 40d arranged on the inboard side of the flange 11 forms an internal flange 41 whose edge 42 has recesses that are congruent with the non-circular peripheral edge 12 of the thickened portion 19 of the hub flange.

Finally, it will be appreciated that the invention is not limited to any particular system or arrangement for the axial locking of the members constituting the unit, which may be selected at random from those known to persons skilled in the art.

1. A hub and braking rotor unit for the wheel of a motor vehicle, comprising:
a rotatable hub having an outwardly projecting radial flange defining an outwardly facing edge,
a braking rotor which is integral with or fixed for rotation with a flange which projects radially inwards and which defines an opening with an internal edge wherein the edges of the two flanges are adjacent to each other and face each other radially,
wherein the edges have, at least along one portion thereof, the same non-circular shape in the same radial plane in order to enable the braking torque to be transmitted from the braking rotor to the hub.

2. A unit according to claim 1, wherein the edges of the two flanges have a same generally oval or elliptical shape.

3. A unit according to claim 1, wherein the edges of the two flanges have substantially congruent profiles viewed in the axial direction.

4. A unit according to claim 1, wherein the two flanges and are substantially aligned in the same radial plane.

5. A unit according to claim 1, wherein the braking rotor is mounted directly on the flange of the hub, wherein the flange projecting radially inwards is formed integrally by the braking rotor.

6. A unit according to claim 1, wherein the braking rotor is mounted on the flange of the hub by the interposition of an annular support member fixed for rotation with the braking rotor and forming the flange which projects radially inwards and which defines the opening with the internal edge.

7. A unit according to claim 6, wherein the annular support member forms a radial flange which projects outwards and which defines an external edge, in that the braking rotor has a flange which projects radially inwards and which defines an opening with an internal edge, where the projecting radial flange of the annular support member is inserted in the opening of the braking rotor, and the edges and of the two above-mentioned flanges are adjacent to each other and face each other in the radial direction, and the edges have, at least along one portion thereof, the same non-circular shape in the same radial plane in order to enable the braking torque to be transmitted from the braking rotor to the support member.

8. A unit according to claim 1, wherein the outwardly facing edge is formed at least in part by the external edge of an axially thickened portion formed on a face of the flange of the hub.

9. A unit according to claim 8, wherein the edge is formed at least in part by a plurality of axially thickened formations which extend radially on a face of the flange of the hub.

10. A unit according to claim 6, wherein the annular support member forms a pair of flanges which project radially inwards and which extend on opposite faces of the flange of the hub, and in that at least one of the two flanges forms an internal edge which faces radially an outwardly facing edge formed by an axially thickened portion on a face of the flange of the hub.

11. A unit according to claim 6, wherein the annular support member is formed by joining at least two complementary curved portions which are joined securely to each other to form a closed ring around the external edge of the hub.

12. A unit according to claim 6, wherein the annular support member is formed by joining two rings of bent sheet-metal which are joined securely to each other along a circumference to form a closed ring around the external edge of the hub.

13. A unit according to claim 1, wherein radial clearance is provided between the facing edges of the two flanges.

14. A unit according to claim 1, further comprising retaining means suitable for blocking or limiting relative axial movements between any two of the components constituting the unit.
